(19) United States
(12) Patent Application Publication
(10) Pub. No.: US 2003/0079121 A1
(43) Pub. Date: Apr. 24, 2003

(54) Secure end-to-end communication over a public network from a computer inside a first private network to a server at a second private network

(75) Inventors: Ralph A. Gilman, San Jose, CA (US); Mary C. Duffy, Sunnyvale, CA (US)

Correspondence Address: APPLIED MATERIALS, INC., 2881 SCOTT BLVD. M/S 2061, SANTA CLARA, CA, 95050, US

(73) Assignee: Applied Materials, Inc., Santa Clara, CA (US)

(21) Appl. No.: 10/007,019

(22) Filed: Oct. 19, 2001

(51) Int. Cl. H04L 9/00

(52) U.S. Cl. 713/153

(57) ABSTRACT

In a semiconductor fabrication facility in which a plurality of fab-owned and operated client systems located within the facility are connected to a fab-owned Intranet using a first physical connection type, a method of allowing an employee associated with a supplier enterprise to access a supplier-owned Intranet owned by the supplier enterprise from a supplier-controlled computing device located within the fabrication facility, a method for allowing secure end-to-end communication between the supplier-controlled computing device and the supplier-owned Intranet. In one embodiment the method includes connecting the computing device to the fab-owned Intranet through a node using a second physical connection type that is different from the first physical connection type; establishing an isolation pipe through the fab-owned Intranet between the node and a hub/firewall using virtual private network technology; generating a request to logon to the supplier-owned Intranet from the computing device; formatting the request in a secure Internet protocol such that the request is broken up into multiple packets, with each packet including at least a header portion and an encrypted data portion; and transmitting the formatted request through the isolation pipe over the fab-owned Intranet to the hub/firewall and then over the public Internet to the supplier-owned Intranet with end-to-end encryption.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to the field of secure communications. More particularly, embodiments of the invention pertain to a method and apparatus for enabling secure end-to-end communication from a computer behind a firewall and inside one private network to a server at another private network over a public network such as the Internet.

The era of instant communication is a reality. The ability to send and receive data from one location to another through the Internet has drastically changed the business environment. Many business tasks, such as ordering parts from a supplier, finding information to solve a hardware problem or sending data offsite for evaluation can now be done faster and more efficiently than ever before.

One key concern of users and companies in this era of the Internet is data security. Much effort has been focused on ensuring that communications sent and received over the Internet can be kept confidential when necessary and cannot be intercepted and read by third parties. These efforts include, among other techniques, the development of various network security protocols, such as the Secure Sockets Layer (SSL) and Secure Hypertext Transfer Protocol (S-HTTP), also known as “Secure HTTP.” Both SSL and S-HTTP use public-and-private key encryption technologies to secure data and are application level (layer 7) services included as part of most standard Web browsers and most Web server products.

Additionally, much effort has been devoted to keeping intruders from accessing data within a company's Intranet or local area network (LAN). Typically, such networks have access points to the Internet through dedicated servers and firewalls. Firewalls protect the resources of a private network from users of other networks. Firewalls work by examining the header of each network packet received from a public network and determining whether or not to allow the packet within the private network based on the security settings and needs of the private network.

While these security measures have led to an increase in confidence in using the Internet for business and other purposes, there are some situations where these measures fall short. As an example, consider modem semiconductor fabrication facilities (sometimes referred to herein as “fabs”). Such facilities may cost billions of dollars to create and operate and may produce billions of dollars worth of semiconductor goods (integrated circuits). As can be readily appreciated, with the financial stakes this high, semiconductor manufacturers vigorously protect the highly confidential information related to the manufacture of integrated circuits, such as data regarding fabrication processes, chip design, etc., that is stored on computer networks at the fabs.

Within these semiconductor fabs are cleanrooms that house semiconductor manufacturing tools. The tools in the cleanroom execute processes or recipes that result in the execution of one or more distinct steps in the manufacture of an integrated circuit. The manufacture of a typical integrated circuit requires dozens if not hundreds of separate processes to be executed by various dedicated tools. The cost of these tools is enormous (often in the millions of dollars) so keeping the tools up and running at a high efficiency level is an important aspect of achieving financial profitability for a particular fab. One way of measuring the output and efficiency of individual tools and of an entire fab is by determining wafer throughput. Throughput generally equals the number of wafers processed in a given time period and is typically expressed in wafers per hours, days or weeks. Maximizing throughput is critical to fab profitability.

A typical semiconductor fabrication facility will include tools from multiple semiconductor equipment manufacturers and may also include teams of engineers (referred to herein as “customer engineers”) from each of these manufacturers that work at the fab to install, and sometimes maintain, the tool in top operating condition. The supplier customer engineers must work in a cleanroom environment the entry to which requires a gowning process for which special clothing such as closed overalls, a hat, gloves, booties and goggles are worn. The semiconductor equipment manufacturers (suppliers) may have other sets of employees working at competing fabs owned by competing semiconductor manufacturers.

Understandably, the semiconductor manufacturers and fab owners are wary about having these employees or customer engineers within their facility. To this end, many fabs and/or semiconductor manufacturers implement tight security practices. These practices may include governing the access to various areas of the fab and the types of items that may be carried into and out of the fab. For example, some fabs have strict rules prohibiting the customer engineers from bringing in any portable computing device or other electronic device with a computer-readable memory that could be used to electronically store confidential information improperly obtained from the fab's premises or to electronically transmit such information to an computer or computer network outside the secure fab area.

While these precautions help protect the fab owner from theft of trade secret and other information, it makes it less efficient for the customer engineers to identify and solve problems with particular tools. The tool manufacturers for whom the customer engineers work often have updated data available that may be used to identify and fix problems with particular tools. Typically, this data is accessible to employees of the tool manufacturer as well as to select customers via the tool manufacturer's computer network, which may be accessed, for example, over the Internet. Because of the security constraints in place at most known fabs, however, customer engineers from the tool manufacturer are not allowed to access this data from where the tool is located within the fab cleanroom. Instead, the engineers are required to go to special areas of the fab or to leave the fab entirely to access the data from another location. This may require the engineer to write down information related to the particular tool problem; degown; walk or drive to the necessary location; log into an appropriate computer to access the necessary Web pages; write down potential answers, information on tests to run, etc.; walk back to the cleanroom; re-gown; and then execute the solution, try a new test or collect more data as appropriate. This procedure may be repeated one or more times as necessary and, as can be appreciated, interferes with the ability of the customer engineer to promptly diagnose and fix the tool's problem, which in turn reduces fab throughput.

Accordingly, it can be seen that there is a need for improving methods of allowing for data communication from within some secure private network facilities, such as semiconductor fabrication facilities, to other private networks over the Internet.

### BRIEF SUMMARY OF THE INVENTION

Embodiments of the present invention provide a method and apparatus for allowing end-to-end secure communication from a supplier client system connected to a customer network, e.g., Intranet, and located behind a firewall at a customer facility to a supplier server system accessed over a public network, such as the Internet, while guaranteeing to the customer that their internal network will remain secure. As used herein, maintaining a secure internal network means that the supplier client system is not able to access any unauthorized private network resources of the customer. This is done by creating an isolation pipe within the customer's private network that isolates all traffic from the supplier client system from all other messages and communications over the private network. Embodiments of the invention also guarantee that the supplier will maintain end-to-end encryption security between the supplier client system at the customer and the remote supplier server attached to the Internet. The invention accomplishes these features using minimal equipment at the customer facility and minimal changes to the customer's existing firewall.

According to one embodiment of the invention, a method for allowing secure end-to-end communication between a computing device located within a semiconductor fabrication facility and a supplier-owned Intranet is provided where the fabrication facility includes a plurality of fab-owned and operated client systems connected to a fab-owned Intranet using a first physical connection type. The method includes connecting the computing device to the fab-owned Intranet through a node using a second physical connection type that is different from the first physical connection type; establishing an isolation pipe through the fab-owned Intranet between the node and a hub using virtual private network technology; generating a request to logon to the supplier-owned Intranet from the computing device; formatting the request in a secure Internet protocol such that the request is broken up into multiple standard Internet packets with each packet including at least a network transmission header and an encrypted data portion; and transmitting the formatted request through the isolation pipe over the fab-owned Intranet to the hub and then through a firewall and over the public Internet to the supplier-owned Intranet.

The invention is not limited to use in just semiconductor fabrication facilities, however. In other embodiments, the present invention provides for end-to-end secure communication over a public network from a client system located behind a firewall of a first private network to a server system associated with a second private network. One particular embodiment includes connecting the client system to a wireless access point of the first private network. Afterwards, a request for a Web page stored on the second private network server system is generated by the client system. This request is transmitted from the client system to the second private network by routing the request, in order, from the client system, to the wireless access point, to a virtual private network node connected to the first private network, to a virtual private network hub connected to the first private network, through the firewall and then over the public network.

According to another embodiment, a networked system is provided. The networked system includes a private communication network, a plurality of customer client systems coupled to the private communication network, a firewall configured to provide security features that enable the customer client systems to connect to a public network; a virtual private network system, and a supplier client system coupled to the private communication network through the virtual private network. The virtual private network system is configured to receive a request from the supplier client system for viewing a desired Web page from over the public network; create a secure pipeline within the private communication network to transmit the request through the private communication network and, in response to receiving the desired Web page from the Internet, transmit the Web page through the private communication network to the supplier client system.

These and other embodiments of the invention along with many of its advantages and features are described in more detail in conjunction with the text below and attached figures.

### BRIEF DESCRIPTION OF THE DRAWINGS

FIG. 1 is a simplified schematic diagram of one common virtual private network configuration between two separate private computer networks using a public network, such as the Internet;

FIG. 2 is a simplified schematic diagram of a possible communication network that theoretically allows for secure end-to-end communication over the Internet from a computer behind a firewall of a first private network to a server on a second private network;

FIG. 3 is a schematic diagram of a communication network according to one embodiment of the present invention;

FIG. 4 is a simplified floor level diagram of a portion of a semiconductor fabrication facility in which embodiments of the present invention may be used; and

FIG. 5 is a flow chart illustrating the steps involved in allowing a supplier customer engineer to access the supplier's Intranet using a workstation located behind the firewall of a fab's private network according to one embodiment of the invention.

### DETAILED DESCRIPTION OF THE INVENTION

As previously mentioned, the present invention provides end-to-end secure communication from a computer behind a firewall and inside a first private network to a server at a second private network over the public Internet. Embodiments of the invention employ virtual private network (VPN) technology within the first private network to create an isolation pipe within the first network that isolates all traffic to and from the particular computer (e.g., a supplier client system) on the private network from all other messages and communications over the private network. In addition, end-to-end encryption is accomplished between the particular computer on the first private network and the server at the second private network over the public Internet. These embodiments prevent the computer (supplier client system) from accessing any unauthorized resources of the private network and thereby guarantee to the customer that their internal network will remain secure, while also guaranteeing to the supplier that messages sent from its server system to and from the particular computer will be secure. The invention accomplishes these features using minimal equipment at the customer facility and minimal changes to the customer's existing firewall. No new holes or ports in the firewall need to be created for such end-to-end communication. Additionally, embodiments of the invention do not encrypt the header information of outbound packets sent from the supplier client system through the firewall to the network server at the second private network. This enables servers at the first network to track how much data is leaving the first network as well as where the data is going.

As used herein, a “client system” is any hand-held (e.g., a personal digital assistant or “PDA”), laptop, desktop or other computer system that can display Web pages generated by a server through a browser or other application program executing on the client system. A “server” is a computer program that provides services to other computer programs in the same computer or on other computers. Often, an individual computer is dedicated primarily or solely to server programs in which case, the computer itself is referred to as a “server.” Also, as used herein, an “Intranet” is a private network that is contained within an organization, company, government body, etc. An Intranet may include many interlinked local area networks as well as leased lines in a wide area network.

In order to better understand the present invention, a brief description of VPN technology is useful. The traditional VPN technology was developed to provide a secure communication link between computers over the public Internet. VPNs secure data communicated over the Internet through the use of strong encryption technology, dual authentication and guarantees of non-tampering while the data is in transit. VPN technology in itself is not new and is well known to those of skill in the art.

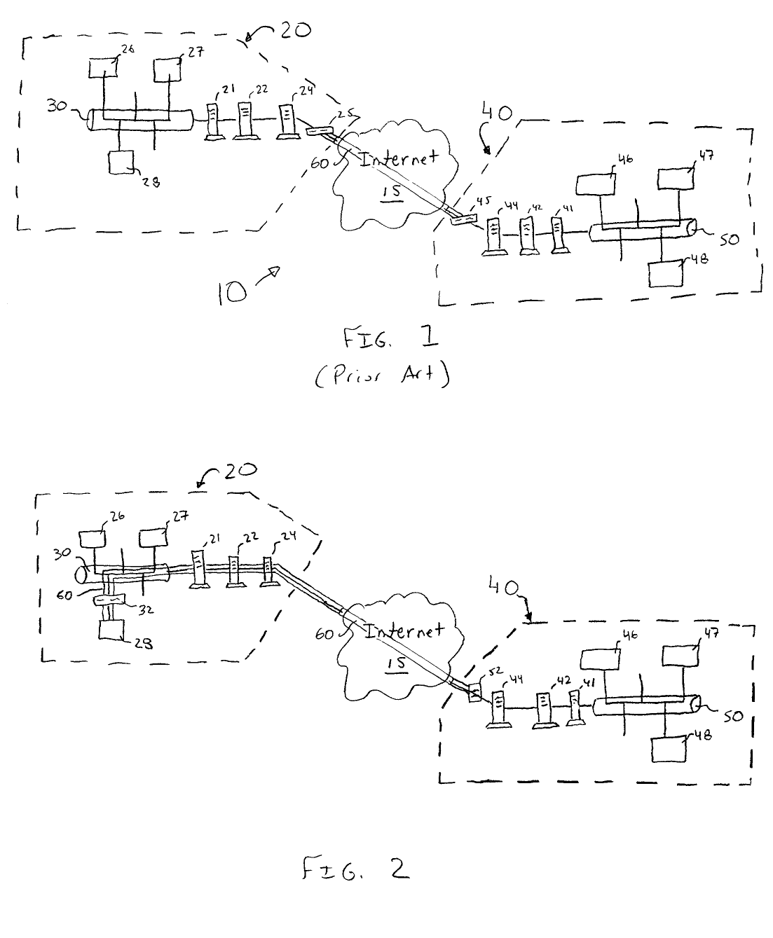

FIG. 1 is a simplified schematic diagram of one common VPN configuration (VPN 10) between two separate enterprises 20 and 40 using a public network, such as Internet 15. Enterprises 20 and 40 are often two different companies, for example, a vendor company and a supplier company, in which case VPN 10 creates an extranet that allows secure communication between the vendor and supplier. As shown in FIG. 1, enterprises 20 and 40 include file servers 21 and 41, proxy-servers 22 and 42, firewalls 24 and 44, VPN routers 25 and 45 and various workstations 26, 27, 28 and 46, 47, 48. The workstations 26 . . . 28 connect to proxy-server 22 through a private Intranet 30. Similarly, workstations 46 . . . 48 connect to proxy-server 42 through a private Intranet 50. Each Intranet 30 and 50 may include one or more linked local area networks as well as leased lines in a wide area network. Workstations 26 . . . 28 and 46 . . . 48 are also referred to as client systems.

Firewalls 24 and 44 are either devices or applications that control the access between Intranets 30 and 50 and external networks such as Internet 15. Firewalls 24 and 44 track and control communication to and from such external networks. Basically, firewalls 24 and 44 decide whether to pass, reject, encrypt or log communications and require that these communications adhere to one or more defined security protocols.

VPN routers 25 and 45 implement the VPN technology by creating security, management and throughput policies for communications between Intranets 30 and 50. To this end, VPN routers 25, 45 form an encrypted tunnel 60 between Intranets 30 and 50. Tunnel 60 protects data sent between the networks from being intercepted and viewed by unauthorized entities. Firewalls 24, 44 perform the functions of packet filtering, hiding internal IP-addresses, and source verification to verify the source of traffic. Proxy-servers 22 and 42 perform the functions of user authentication to ensure that unauthorized users are not granted access to the network prescribing the access privileges that users are permitted, logging activity, and acting as a proxy or buffer by re-writing all traffic it handles so no client system inside can talk directly to the outside or vice-versa.

Tunnel 60 provides logical, point-to-point connections across the otherwise connectionless Internet, enabling application of advanced security features for communications between Intranets 30 and 50. A number of different known tunneling protocols are available for use including the Point-to-Point Tunneling Protocol (PPTP), the Layer 2 Tunneling Protocol (L2TP, Layer 2 Forwarding (L2F) and generic routing encapsulation (GRE). Also, standard encryption technologies can be used including the Data Encryption Standard (DES) developed by IBM, 3DES, and the 40/128-bit RC4 for Microsoft Point-to-Point Encryption (MPPE).

A variety of different hardware and software components are available to implement the VPN solution shown in FIG. 1. Examples of manufacturers of VPN hardware equipment include Alcatel, Cabletron, Cisco Systems, Netscan Technologies, Nokia, Nortel and Radguard. In some applications separate hardware and software components are employed as firewalls 24, 44 and VPN routers 25, 45, while in other applications a single hardware or software component is employed as both firewalls 24, 44 and VPN routers 25, 45.

In order to compare the VPN configuration shown in FIG. 1 to the type of secure communication network desired for use within semiconductor fabrication facilities, enterprise 20 can be equated to a semiconductor fabrication facility and enterprise 40 can be equated to the semiconductor tool equipment manufacturer (supplier). Extending this comparison further, assume workstations 26 and 27 represent fab-owned computer resources of a fab-owned Intranet while workstation 28 represents the semiconductor tool manufacturer computer for which it is desirable to have secure end-to-end communication to semiconductor tool manufacturer server 42. In order to simplify discussion on this matter, hereinafter, the semiconductor fabrication facility is sometimes referred to as the “customer” and the semiconductor tool manufacturer is sometimes referred to as the “supplier.” Thus, server 42 can be referred to as a “supplier server” and workstation 28, which is able to view Secure Web Pages generated by server 42, can be referred to as a “supplier client system” at the customer.

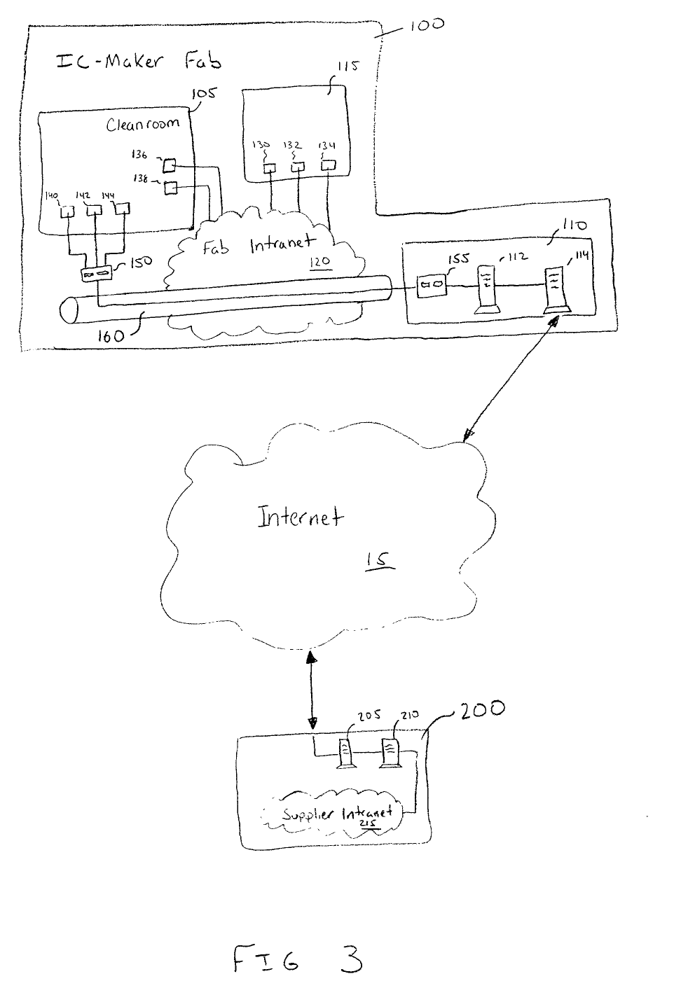

With the above comparison in mind, it can be seen that supplier client system 28 is not isolated from other fab-owned workstations on Intranet 30, such as workstations 26 and 27. Accordingly, client system 28 is a potential security threat to confidential data stored on Intranet 30. One possible option to solve this problem is shown in FIG. 2. As shown in FIG. 2, a VPN router 32 can be moved to a position behind firewall 24 and placed between client system 28 and Intranet 30, while a VPN router 52 is added to Intranet 50. This configuration would create an encrypted tunnel from VPN router 32 to VPN router 52 theoretically allowing messages from client system 28, through firewall 24, over Internet 15 and to server 42. Alternatively, VPN router 32 could be incorporated as software in the client computer 28.

The solution shown in FIG. 2 is, however, disfavored by most network security managers, including those in semiconductor fabrication facilities, because VPN protocols can be a security issue when linked to individual PCs inside the fab domain. Generally, VPN-tunneling works at ISO Levels 2 and 3. VPN encrypts the protocol used as well as the data, and the protocol encryption thus hides the tunneled transaction from firewall scrutiny. Also, encryption of protocols opens the possibility of allowing an unacceptable protocol to reach a PC connected internally as a trusted resource. This raises a concern that an outside agent could take over the VPN-PC and then move backward to switches, routers and servers creating a major security problem.

Another potential network configuration for providing the desired level of security uses virtual LAN technology. This technique (not shown in a diagram) employs routers and switches with virtual LAN functionality at all points in the private fab-owned network to logically control all packets generated from supplier client systems and direct such packets through the fab Intranet without allowing the supplier client systems access to Intranet resources. This solution requires that all routers on a given Intranet be virtual LAN capable and also has problems when working across multiple subnets on an arbitrary LAN architecture.

As can be seen from the above, none of the potential network configurations just described provide the end-to-end secure communication from a supplier client system located behind a firewall of a private customer network to a supplier server system accessed over a public network while guaranteeing to the customer that their internal network will remain secure as is desired for use within semiconductor fabrication facilities. Embodiments of the present invention do provide such a system by using VPN hardware (or software) to create an isolation pipe within the customer's internal Intranet that isolates all traffic from the supplier client system from all other messages and communications over the Intranet thereby preventing the supplier client system from accessing any unauthorized private network resources of the customer. Thus, in effect, embodiments of the invention use VPN technology to keep supplier traffic on an internal private network “inside” the pipe whereas traditional VPN technology is used to keep hackers on the Internet “outside” the pipe.

The invention accomplishes these features using minimal equipment at the customer facility and minimal changes to the customer's existing firewall. No new holes or ports in the firewall need to be created for such end-to-end communication. Additionally, because the VPN isolation pipe ends within the fab-owned private network, embodiments of the invention do not encrypt the header information of outbound packets heading to the Internet. This enables firewall and proxy-servers at the customer facility to track how much data is leaving the customer's facility and where the data is going.

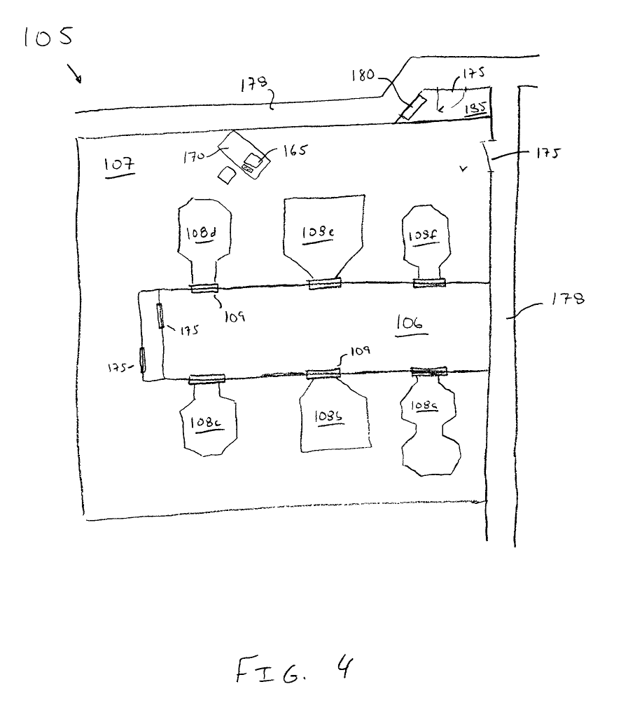

FIG. 3 is a schematic diagram of a communication network according to one embodiment of the present invention. Shown in FIG. 3 are semiconductor fabrication facility 100 (customer 100) and semiconductor tool manufacturer 200 (supplier 200). Fab facility 100 includes a cleanroom 105, an Internet security complex 110 and other work areas 115. Internet security complex 110 includes a proxy-server 112 and firewall 114. An internal private network, Intranet 120, allows individual fab-owned workstations, such as workstations 130, 132, 134, 136 and 138 at the fabrication facility to communicate with each other, access fab computer resources and access Internet 15. Proxy server 112 acts as an intermediary between the individual workstations and the Internet, and firewall 114 provides typical firewall filtering functions.

Semiconductor tool manufacturer 200 also includes a firewall 205, a Web-proxy server 210 (that generates Secure Web Pages for end-to-end encryption and viewing by client systems over the Internet and inside Customer facilities), and an Intranet 215. In one embodiment, Web-proxy server 210 is an iPlanet server manufactured by Sun Microsystems, Inc. that provides gateway services at the application level with a web proxy. In other embodiments, server 210 also provides gateway services at the circuit level through the SOCKS protocol.

Referring back to fab 100, workstations 140, 142, 144 in cleanroom 105 are associated with customer engineers working for one or more suppliers, such as supplier 200. It is a feature of embodiments of the present invention to provide secure end-to-end communication from each workstation 140, 142, 144 to server 210 at supplier 200. Workstations 140, 142 and 144 can be desktop personal computers, mobile computers, personal digital assistants (PDAs) or other computing devices that can be connected to Intranet 120. Such secure communication is achieved using a combination of (1) Secure Web Pages for transmission of information over Internet 15 for the security of suppliers 200 and (2) VPN technology for isolated transmission of information within fab-owned Intranet 120 for the security of fab 100. Thus, the fab 100 can set up one isolation pipe 160 that can be used by all suppliers 200 with assured security for fab 100. Each supplier 200 is then responsible for their own authentication and end-to-end encryption using Secure Web Pages or other appropriate protocol. Communications to and from a particular supplier through pipeline 160 and over Internet 15 are protected from being intercepted by other suppliers by the Secure Web Pages encryption techniques.

In order to protect the confidentiality of information transferred over the Internet, each Web Page transferred between a supplier client system and supplier 200 is a Secure Web Page. As used herein a “Secure Web Page” is a Web page that is encrypted for transmission over the Internet and not decrypted until it reaches its destination computer, for example, the supplier client system. Secure Web Page encryption is initiated by supplier client systems 140, 142, 144 when a request for information is sent to one of the suppliers 200, but such encryption is enforced by the individual supplier proxy server 210. Secure Web Page encryption gives each supplier 200 assurance that all communications sent by that supplier are fully encrypted along the entire communication chain, from server 210 to the appropriate client system 140, 142 or 144. In one embodiment, Secure Web Page encryption is provided using the industry standard SSL protocol developed by Netscape. Due to the wide use of Web Pages and the Internet, firewall 114 is typically already configured by customer 100 to allow such Secure Web Pages through (e.g., port 443 is dedicated to SSL communications) with no additional set-up steps or rules to implement.

One benefit of relying on Secure Web Pages for security over Internet 15 as compared to a VPN solution such as the one illustrated in FIG. 2 is that Secure Web Pages only encrypts packet data and does not encrypt the network transmission headers. Thus, using this technique allows network security managers at fab 100 to monitor all traffic passing through firewall 114 to client systems 140, 142, 144 and also allows firewall 114 and/or other servers associated with network security to filter unwanted traffic based on the headers.

The Intranet-VPN portion of this solution is implemented through the placement of VPN nodes and hubs at appropriate places within fab-owned Intranet 120. Each workstation 140, 142, 144 is then connected to Intranet 120 through a VPN node 150. Depending on the number of and locations of supplier client systems at Fab 100, multiple VPN nodes 150 may be employed. Each VPN node 150 is set up to communicate only with VPN hub 155 and not with other devices on the network. Thus, messages passed to each node 150 are directed from the node to VPN hub 155. From hub 155, communications can pass through proxy-server 112 and firewall 114 to the Internet.

VPN node 150 and VPN hub 155 combine to create a supplier isolation pipe 160 (i.e., a tunnel created using standard VPN tunneling and encryption technology) within Intranet 120 that keeps all traffic to and from the supplier workstations within the tunnel. This is done by ensuring that supplier data traffic cannot view or access any other IP-addresses on Intranet 120. Thus, in effect, workstations 140, 142 and 144 cannot “see” any of the private network resources that are generally accessible to workstations having appropriate access rights, even though the packet traffic is being transmitted over the existing arbitrary Intranet system of LAN wires, routers and switches.

VPN node 150 and hub 155 can employ any standard VPN security technique to create supplier isolation pipe 160. As is known to those of skill in the art, these techniques use an appropriate tunneling protocol to ensure that data through the isolation pipe 160 stays within the isolation pipe. These techniques may also encrypt messages transmitted through the tunneled connection to scramble data making it legible only to authorized senders and receivers. The encrypted data is then decrypted at the other end of the tunnel.

This VPN-level encryption includes encrypting both packet header information and packet data. Also, the VPN-level encryption is on top of the Secure Web Page encryption protocols. Thus, packets transmitted through isolation pipe 160 are doubly encrypted in the non-header, data portion of transmitted packets. VPN node 150 and hub 155 can also combine to form packet authentication, intrusion detection, security auditing and user authentication among other VPN/firewall features as would be understood by a person of skill in the art. Outside of isolation pipeline 160, the network transmission header part of a packet is not encrypted, allowing either proxy-server 112 or firewall 114 to log all communications leaving private network 120 for, and arriving at private network 120 from, Internet 15.

In some embodiments, additional security is provided by filtering outbound IP addresses and/or preventing unsolicited inbound traffic. For example, firewall 114 and/or VPN hub 155 can be further set up to filter all outbound IP addresses to a list of predetermined supplier Web site addresses and/or to filter outbound access to allow only communications using standard SSL Secure Web Page ports. If a request is generated by a supplier client system to an IP address that is not on the list of approved, predetermined supplier Web site addresses or that does not use a Secure Web Page port, the request will be denied. Such a set up effectively prevents general Internet surfing and limits the use of the supplier workstations to obtaining information from the predetermined Web sites.

Also, VPN hub 155 and/or firewall 114 can be set up to prevent the receipt of unsolicited inbound traffic to the supplier workstations even when such traffic is transmitted from an approved Supplier server. As is known to those of skill in the art, in the SSL protocol each IP-packet includes a bit that represents whether or not the packet is associated with a connection that has already been established between a client system and a server. If no connection was previously established, this bit is set when an initial communication is started to indicate a request to establish a new connection. Thus, the first packet associated with a new, unsolicited communication generated from outside Intranet 120 to a client system connected to Intranet 120, including any one of client systems 140, 142, 144, would include an established connection bit that is set. Unsolicited inbound traffic is thus prevented by setting up VPN hub 155 to not allow packets having the established connection bit already set through to Intranet 120. Upon receiving a packet with such a set “established connection bit,” hub 155 and/or firewall 114 simply drop the packet, not allowing to enter Intranet 120.

Also, as previously mentioned, VPN hub 155 and/or firewall 114 track the various communication sessions between supplier client systems 140, 142, 144 and the outside world and only allow inbound packets that are associated with an already established communication session. Thus, packets received at VPN hub 155 and/or firewall 114 that do not have the established bit set, are not guaranteed entry onto Intranet 120. Before entry is granted, VPN hub 155 and/or firewall 114 checks to see if the packets match up with an existing communication session that is taking place between one of workstations 140, 142, 144 and Internet 15. Only packets that can be matched with such a communication are allowed through. Thus, VPN hub and/or firewall 114 only allow packets into Intranet 120 when (1) the packets do not have a set established connection bit and (2) the packets can be identified as pertaining to one of the already established communication sessions that was initiated from within Intranet 120.

In still other embodiments, personal firewall software is installed on all supplier client systems to check that all outgoing protocols from the supplier client system meet defined security requirements. Should a disallowed protocol be detected, it would be blocked, and, as an additional option, an email can be sent to both an appropriate fab security personnel and to supplier 200 to record the excursion.

Hardware to implement the functionality of VPN node 150, VPN hub 155, proxy server 112 and firewall 114 is readily available. For example, in one embodiment VPN node 150 is a PIX 501 VPN firewall manufactured by Cisco Systems and VPN hub 155 is a Secure PIX 506 VPN firewall also manufactured by Cisco Systems. Each PIX 501 node can handle up to about a dozen individual supplier client systems so additional PIX 501 devices are required for the connection of more than a dozen supplier client systems, or to expand functionality to multiple physically separated locations. Proxy server 112 and firewall 114 are typically already owned by and installed in fab 100, and may be, for example, Checkpoint software running on a large Unix server for the firewall or Netscape Software running on an NT server for the Web proxy(s).

As can be appreciated from the above description, the creation of isolation pipe 160 within Intranet 120 provides effective security measures that enable the supplier customer engineers to access, from a workstation behind the fab firewall, data from their supplier corporate Intranet. Isolation pipe 160 also ensures that the workstations the customer engineers are using cannot access inappropriate resources of the fab 100-owned private network 120. In reality, however, this security scheme is only effective for the specific network connections that are directed towards appropriate VPN nodes, such as node 150. Often, a given customer engineer will be connecting to Intranet 120 using a laptop or other portable computing device. Thus, security measures need to be in place to ensure that customer engineers cannot connect such a computing device to a network connection that bypasses VPN 150. For example, assuming workstation 136 is connected to Intranet 120 using a standard CAT-5 Ethernet cable connection, security measures need to be in place to prevent a customer engineer from unplugging workstation 136 from that connection and plugging his or her own portable computing device into the connection.

To this end, one additional physical isolation level of security is implemented in certain embodiments of the invention. This physical isolation level requires that portable or other computing devices used by customer engineers within the fabrication facility use a type of physical connector that is different than the physical connectors used by all other workstations in the facility. Specially designated connecting points that use this second type of physical connector are then established in appropriate places at the fab including in cleanroom 105 to allow the supplier portable computing devices to connect into tunnel 160 on Intranet 120. These designated connecting points are wired in a manner that places VPN node 150 between the connecting point and Intranet 120. As an example, if all customer-owned workstations connect to Intranet 120 using standard CAT-5 Ethernet connectors, the Ethernet drops in the cleanroom wall used for portable computing devices used by customer engineers must use some physical connector other than CAT-5. Also, the portable computing devices used by the customer engineers cannot include a network card that accepts a CAT-5 connector. Instead, any network card installed in such a portable computing device must rely on the same type of connection format used in the designated customer engineer Ethernet drops.

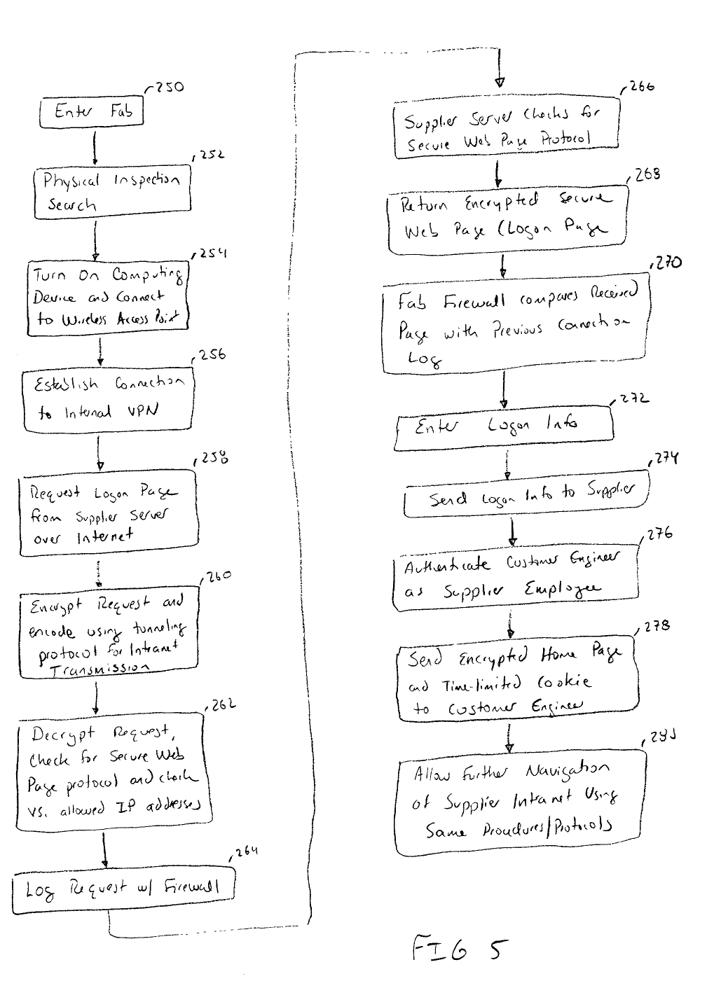

In one embodiment, this physical isolation security level is accomplished with a wireless LAN. Thus, all supplier portable computing devices are equipped with an appropriate wireless network card. FIG. 4, which is a simplified floor level diagram of a portion of a semiconductor fabrication facility, shows an example of such a solution.

Shown in FIG. 4 is a small portion of cleanroom 105 including a central wafer handling area 106 and a tool area 107. Central wafer handling area 106 is a highly purified area (e.g., a class 100 area—no more than 100 particles larger in 0.5 micron diameter per cubic foot) in which substrates are transferred between individual semiconductor tools using a standard transfer pod (not shown). Tool area 107 is slightly less purified (e.g., a class 1000 area) and includes the main bodies of the different semiconductor processing tools 108a.108f used to process substrates transferred into area 106. Substrates are placed in tools 108a.108f through interfaces 109 to the tool in the wall of handling area 106. Customer engineers work within area 107 from where they have access to the various tools 108. Also, in area 107 are workstations, such as workstation 165, which when necessary, can be used to diagnose and fix any problems with individual tools by connecting to the tool manufacturer's Intranet in accordance with the techniques of the present invention. Doors 175 and hallways 178 allow physical access to the different portions of cleanroom 105.

As described above, it is often useful to access data and other information stored on private computer network owned and operated by the tool supplier when performing such diagnostic and/or other tests. In FIG. 4, workstation 165 is shown as a portable computing device positioned at a desk 170. Portable computing device 165 includes a wireless network card that connects to a wireless network access point 180 (a wireless transmitter) that is placed in a secure area of the fab. In FIG. 4, wireless network access point 180 is placed in a locked closet 185 that is located outside of tool area 107, but in other embodiments access point 180 can be physically separated from tool area 107 by placing the access point could be in a locked cabinet or closet within the cleanroom, or in the appropriate locations outside of the cleanroom, such as above the ceiling tiles. Other fab-owned and operated client systems within cleanroom 105 connect to Intranet 120 using a different type of physical connection, for example, CAT-5 connectors or a wireless standard that is not compatible with network access point 180.

Wireless access point 180 connects to Intranet 120 through VPN node 150. Thus, all communications from the supplier portable computing devices are sent from wireless access point 180 to VPN node 150 and then through supplier isolation tunnel 160. While not shown in FIG. 4, within a given fab there may be multiple secure areas that are serviced by different wireless access points. The wireless cards in a given customer engineer's computing device can be programmed to work with only selected ones of the wireless access points on an as needed basis. Communication between workstation 165 and wireless access point 180 can be done using any of the several standards for such wireless network connections, such as the IEEE 802.11b standard for wireless communications. In one specific embodiment, wireless access point 180 is an Aironet 350 Series Access Point transmitter manufactured by Cisco and the supplier portable computer computing devices all include 802.11b wireless receiver cards. Each Aironet 350 Series transmitter can transmit a signal about 100 feet inside the fab and can support 10 supplier client systems.

As evident from the above, FIGS. 3 and 4 and the associated text provide a complete description of one embodiment of a communication network according to the present invention. In order to better understand the security features available according to certain embodiments of the invention, reference is now made to FIG. 5, which is a flow chart showing the steps involved in allowing a customer engineer associated with supplier 200 within tool area 107 to access supplier Intranet 215 using a portable computing device such as a workstation 165. For purposes of explanation the discussion with respect to FIG. 5 assumes other non-customer engineer client systems in fab 100 connect to Intranet 120 using CAT-5 connectors.

As shown in FIG. 5, before a customer engineer can access a Supplier Web page from within a fab, the customer engineer enters the fab through a security checkpoint (step 250). Security personnel at the checkpoint visually inspect any portable computing device carried by the customer engineer to ensure that it does not have a CAT-5 Ethernet card that would enable the computing device to be connected to standard LAN drops (step 252).

After passing through the necessary checkpoint(s) and arriving at area 107, a customer engineer can turn on his or her portable computing device and start a browser to logon to the supplier's secure web site (step 254). Prior to performing such a logon process, the wireless card in portable computing device 165 contacts a nearby, but physically isolated wireless access point, such as wireless access point 180. Once contacted, access point 180 blocks all user requests from workstation 165 until the workstation has been authenticated. In one embodiment, the authentication process is an additional logon process where the customer engineer provides a username and password to access wireless access point 180. In another embodiment, however, the authentication process proceeds automatically based on permissions stored in wireless access point 180 and identification information stored on workstation 165.

After workstation 165 has been authenticated to wireless access point 180, a connection is established between the workstation and VPN node 150 (step 256). At this point, the customer engineer can request to logon to the supplier's Intranet 215 (step 258). The login process requests to display the supplier logon page on portable computing device 165. This request, which is directed to Internet 15 is first encrypted (step 260) and then sent through packets over internal Intranet 120 directly to the VPN hub 155 through isolation pipeline 160.

VPN hub 155 receives and decrypts the request, checks to ensure it uses an appropriate Secure Web Page port and checks to see if the destination address is on the list of approved Supplier IP-addresses (step 262). Assuming the particular requested page is a Secure Web Page on the list of supplier IP addresses, the firewall logs the request and sends it over the Internet to the supplier's Secure Web Site (step 264).

Upon receiving the request, the supplier's web site checks for the SSL protocol (step 266) and, if found, returns an encrypted Login page that is encrypted all the way to the portable computing device (step 268). Customer firewall 114 checks its log of previously established connections and allows packets of the encrypted Web page through since they are part of a reply to a previously logged internal request (step 270).

At this point, the customer engineer enters appropriate information to logon to the supplier Intranet (step 272). In one embodiment this information provides dual authentication by requiring both (1) information known to the customer engineer and (2) something possessed by the customer engineer. The “known information” may include, for example, a login ID and a password, while the “thing possessed” may include a SecurID token available from RSA Security. A SecurID token provides an easy, one step process to positively identify network and system users and prevent unauthorized access. The token, which can be a credit-card sized belt clip or carried as part of a key chain, works in conjunction with hardware or software running on the supplier's server system to generate a new, unpredictable code every 60 seconds that is known to the supplier server. Thus, to logon on to supplier Intranet 215, the customer engineer enters a username, password and the code generated by his/her SecurID token (step 272). This information is sent to supplier 200 using the same process as the request to display the supplier's logon page described with respect to steps 260-266 (step 274).

Once supplier server 210 authenticates the customer engineer as a valid employee (step 276), an encrypted Supplier Home page with a time-limited encrypted cookie for authentication of future transmissions is sent to workstation 165 (step 278). The customer engineer can now navigate the Supplier Web site as desired to obtain selected information and data (step 280). Each subsequent page request made from the customer engineer is passed to the Supplier server in the manner described above along with the just-received time-limited cookie. Secure Web Pages are passed back to workstation 165 in response to these requests only if the time-limited cookie has not expired. Each Secure Web Page that is passed back to the customer engineer also comes with a new time-limited encrypted cookie. Future Secure Web Pages are sent to the customer engineer only if the correct returned encrypted cookie is passed back to supplier server 210 with the page request. In one embodiment, the cookies expire 15 minutes after generation thereby requiring the customer engineer to respond within this 15 minute window or to re-logon to server 210 using the process just described.

After the customer engineer has completed his or her tasks, he logs out of the system thereby telling supplier server 210 to drop the authentication session. As an extra security measure, some embodiments of the invention drop the session automatically after a period of time, for example 100 minutes, regardless of the activity level.

Having fully described several embodiments of the present invention, many other equivalents or alternative embodiments of the present invention will be apparent to those skilled in the art. For example, while the invention was described as including VPN-level encryption for transmission of messages within isolation pipe 160, this extra VPN encryption is not used in all embodiments. In some embodiments, either minimum level VPN encryption or no encryption within tunnel 160 is used to increase speed. Also, while the invention was described as including a single isolation pipe 160 that can be shared by multiple suppliers, separate tunnels can be created in other embodiments. Separate tunnels are useful, for example, if separate secure communications are required other than for customer engineer access, such as sharing of highly secure direct tool processing data.

In still other embodiments, separate dedicated wiring is used to connect each supplier client system at the fab directly to the fab's firewall instead of using the VPN tunneling techniques described above. This embodiment still enables the secure end-to-end communication described herein by requiring (1) separate physical connection types for the supplier client systems than other work stations at fab 100 and (2) the use of Secure Web Pages for communications to the supplier server. The separate dedicated wiring alleviates the need for isolation tunnel 160 as any supplier client system connected in this manner is physically isolated from the fab's internal Intranet. Also as mentioned in the Summary of the Invention section above, the method of the invention may find uses in applications other than semiconductor fabrication facilities. These equivalents and/or alternatives are intended to be included within the scope of the present invention.

What is claimed is:

1. A method of allowing an employee associated with a first enterprise to access a first Intranet owned by the first enterprise from a computing device located within a semiconductor fabrication facility in which a plurality of client systems located within said facility are connected to a second Intranet using a first physical connection type, said fabrication facility, plurality of client systems and second Intranet all being owned by a second enterprise, said method comprising:
connecting said computing device to said second Intranet through a node using a second physical connection type that is different from said first physical connection type;
establishing an isolation pipe through said second private Intranet between said node and a hub using virtual private network technology;
generating a request to logon to said first Intranet from said computing device;
formatting said request in a secure Internet protocol such that said request is broken up into multiple standard Internet packets, where each packet includes at least a network transmission header portion and an encrypted data portion; and
transmitting said formatted request through said isolation pipe over said second Intranet to said hub and then through a firewall and over the public Internet to said first Intranet.

2. The method of claim 1 wherein said formatted request is received at the first private Intranet.

3. The method of claim 1 wherein said formatted request is transmitted through said isolation pipe using a tunneling protocol selected from the group consisting of: layer 2 tunneling protocol, point-to-point tunneling protocol, layer 2 forwarding and generic routing encapsulation.

4. The method of claim 1 wherein said formatted request is encrypted using a Secure Sockets Layer (SSL) encryption protocol.

5. The method of claim 5 wherein both the network transmission header and already encrypted data portions of each packet associated with said formatted request is encrypted at said node using a VPN-level encryption protocol prior to being transmitted through said isolation pipe and then decrypted at said hub/firewall such that the header is unencrypted and the data portion is encrypted using only the SSL protocol prior to being transmitted over the public Internet.

6. The method of claim 1 wherein said first enterprise is a semiconductor equipment manufacturer.

7. The method of claim 1 wherein said computing device is connected to said second Intranet from inside a cleanroom.

8. In a customer network comprising a plurality of customer client systems, at least one customer server system and a customer firewall where said plurality of customer client systems are communicatively coupled to said server system using a first physical connection type, said server system is communicatively coupled to said firewall and said customer firewall is communicatively coupled to a public network, a method of allowing end-to-end secure communication from a supplier client system located behind said firewall to a supplier server system accessible over said public network, said method comprising:
connecting said supplier client system to said customer network using a second physical connection type that is different from said first physical connection type;
establishing an isolation pipe between said supplier client system and a server system of said customer network through use of a tunneling protocol;
transmitting data from said supplier client system through said customer network and towards said firewall using said isolation pipe;
transmitting said data from said customer firewall to said public network; and
receiving said data at said supplier server system.

9. The method of claim 8 further comprising:
in response to receiving said data at said supplier server system, transmitting data from said supplier server system to said supplier client system.

10. The method of claim 9 wherein the public network is the Internet and wherein data from said supplier system that is transmitted through said customer network is formatted in a secure Internet protocol such that said data is broken up into multiple standard Internet packets, where each packet includes at least a network transmission header portion and an encrypted data portion.

11. The method of claim 10 wherein said secure Internet protocol is the Secure Sockets Layer (SSL) protocol.

12. The method of claim 11 wherein said isolation pipe through said customer network is established by a virtual private network hub and a virtual private network node and said supplier client system is connected to said customer network through said virtual private network hub.

13. A method for allowing end-to-end secure communication over a public network from a client system located behind a firewall of a first private network to a server system associated with a second private network, said method comprising:
authenticating communication between said client system and a wireless access point of said first private network;
thereafter, generating, from said client system, a request for a Web page stored on said server system;
transmitting said request from said client system to server system by routing said request through said first private network, over said public network and then to said second private network, wherein said request is routed through said first private network, in order, from said client system, to said wireless access point, to a virtual private network node, to a virtual private network hub, and through said firewall and wherein said request is routed from said virtual private network node to said virtual private network hub using a tunneling protocol.

14. The method of claim 13 wherein said client system is located in a cleanroom of a semiconductor fabrication facility and said wireless access point is located outside said cleanroom.

15. A networked system comprising:
a private communication network;
a supplier client system coupled to the private network;
a firewall coupled to the network, said firewall providing security features that enable said private network to connect to a public network; and
a virtual private network system, coupled to the private network;
wherein said virtual private network system is configured to:
receive a request from said supplier client system for viewing a desired Web page sent over the public network, create a secure pipeline within said private communication network tunnel to transmit said request from said supplier client system to said firewall and transmit said desired Web page from said Internet through said firewall to said supplier client system.

16. The system of claim 15 wherein said supplier client system is configured to generate said request in a secure Internet protocol such that said request is broken up into multiple standard Internet packets, where each packet includes at least a network transmission header portion and an encrypted data portion.

17. The system of claim 16 wherein said virtual private network system comprises at least a VPN node and a VPN hub, and wherein said supplier client system is coupled to said private network through said VPN node and said VPN node directs communications through said private network directly to said VPN hub.

18. The system of claim 17 wherein said VPN node is configured to transmit only requests generated in said secure Internet protocol to said VPN hub.

19. The system of claim 18 wherein said secure Internet protocol is the Secure Sockets Layer (SSL) protocol.

20. A networked system comprising:
a private communication network;
a virtual private network (VPN) node coupled to said private network;
a supplier client system coupled to the private network through said VPN node;
a VPN hub coupled to said private network, wherein said VPN node and VPN hub are configured to create an isolation pipe therebetween within said private network;
a firewall coupled to the private network, to said VPN hub and to a public network, said firewall providing security features that enable said private network to connect to the public network.

21. The networked system of claim 20 wherein:
said VPN node is configured to receive a request from said supplier client system for viewing a desired Web page sent over the public network and pass said request on to said VPN hub using a tunneling protocol;
said VPN hub is configured to pass said request from said VPN node to towards said firewall; and
said firewall is configured to transmit said request over said public network.

22. The system of claim 21 wherein said VPN node is configured to transmit only requests generated in said secure Internet protocol to said VPN hub.

23. The system of claim 22 wherein said secure Internet protocol is the Secure Sockets Layer (SSL) protocol.
